(19) United States
(12) Patent Application Publication
(10) Pub. No.: US 2015/0246500 A1
(43) Pub. Date: Sep. 3, 2015

(54) MACHINE AND METHOD FOR PRODUCING A TUBULAR ELEMENT BY WINDING A CARDBOARD STRIP IN A COIL PATTERN WITHOUT USE A QUICK-SETTING HOT GLUE

(71) Applicant: Gambini International S.A., Luxembourg (LU)

(72) Inventor: Giovanni Gambini, Pisa (IT)

(21) Appl. No.: 14/634,109

(22) Filed: Feb. 27, 2015

(30) Foreign Application Priority Data
Feb. 28, 2014 (IT) MI2014A 000320

(51) Int. Cl. B31C 11/04; B31D 5/00

(52) U.S. Cl. CPC B31C 11/04; B31D 5/0086

(57) ABSTRACT

Machine for producing a tubular element by winding a cardboard strip (11) in a coil pattern and subsequently cutting it (17) to size; said machine being of the type comprising a winding pin (13) on which said cardboard strip (11) is wound in a coil pattern partially overlapping so as to form an overlapping area (12) between subsequent turns of the coil and a dispenser (14) of glue (18) configured to apply said glue (18) on said strip (11) within said overlapping area (12); the machine also comprises means for cyclically arranging adhesive labels (20) astride the edge of said strip (11) at the areas undergoing the subsequent cutting operation (17).

The present invention refers to a machine for producing a tubular element by winding a cardboard strip in a coil pattern and subsequently cutting the single elements to size.

The present invention also refers to a method for making the aforementioned cardboard tube.

In particular, the present invention refers to making tubular elements intended to be used as internal support, or core, in rolls of toilet paper, kitchen roll, rolls of adhesive tape or other.

Machines for producing cardboard tubes are currently known, referred to in the field as “tube machines”, comprising a coil winding group of a cardboard strip about a pin element.

The winding group is commonly formed from a belt relayed over two pulleys so that at least one branch of the belt is wound in a loop about the pin to stretch over it at least part of an overlapping portion of the cardboard strip being wound.

In order to keep the strip stably wound in a coil, it is provided to use glue, usually cold liquid glue, arranged at the overlapping sections of the strip being wound.

In order to manage the correct manufacture of the tubes, it is fundamental to control the dispensing of the glue on the strip being wound.

Indeed, incorrect dispensing of glue could even lead to the risk of dirtying the winding pin or even preventing the correct feeding of the portions of tube, or cores, to other machines, for example a reeling machine.

However, even correct dispensing of the glue can lead, during the cutting step, to detachment of the pointed edges, known in the field as “becche”, that form in the cutting area along the edge of the strip wound in a coil.

In order to avoid the formation of these “becche” (or “detached edges”) it is currently known to also dispense quick-setting hot glue in these portions, in addition to the cold liquid glue.

An example of this solution currently known is described in patent EP1718455.

Such a patent, in particular, teaches on the one hand to take care of dispensing hot glue discontinuously to reduce the costs and on the other hand to control its application on the strips so that a section of glue is indeed astride of the cutting area.

However, the use of hot glue, in addition to problems of costs, has drawbacks linked to the safety of the user who is close to the machine.

Indeed, hot glue, by its definition, is deposited at a high temperature, taken from a melter at about 180° and dispensing it with equally hot nozzles.

These glowing elements, as it can easily be deduced, constitute a source of danger and therefore often require that the machine be equipped with further casings to protect workers.

Starting from the aforementioned prior art, the purpose of the present invention is to make a machine for producing a tubular element by winding a cardboard strip in a coil pattern that is an alternative to those currently known and capable of ensuring the same results in terms of preventing the formation of “becche” (or “detached edges”) during the cutting step of the tubes without using quick-setting hot glue, which is very expensive, in addition to cold liquid glue.

These purposes according to the present invention are accomplished by making a machine for producing a tubular element by winding at least one cardboard strip in a coil pattern as outlined in claim 1.

In general, the present invention achieves the aforementioned purposes providing a cyclical arrangement of adhesive labels astride the edge of the strip at the areas undergoing the subsequent cutting operation.

In the various forms of the invention such labels can be arranged on the strip before winding, on the back or on the bottom, or after winding before cutting.

It should be specified that the term back and bottom respectively mean the face of the strip opposite to and facing the pin.

By doing this, the costs are reduced without the risk of creating areas of detachment of the edges during cutting. Indeed, the edges of the strip at the cutting line are held in position by the adhesive label.

Further characteristics of the machine and of the relative method will be specified in the rest of the description and in the dependent claims.

The characteristics and advantages of a machine for producing tubes of cardboard according to the present invention and of a relative method will become clearer from the following description, given as an example and not for limiting purposes, referring to the attached schematic drawings, in which:

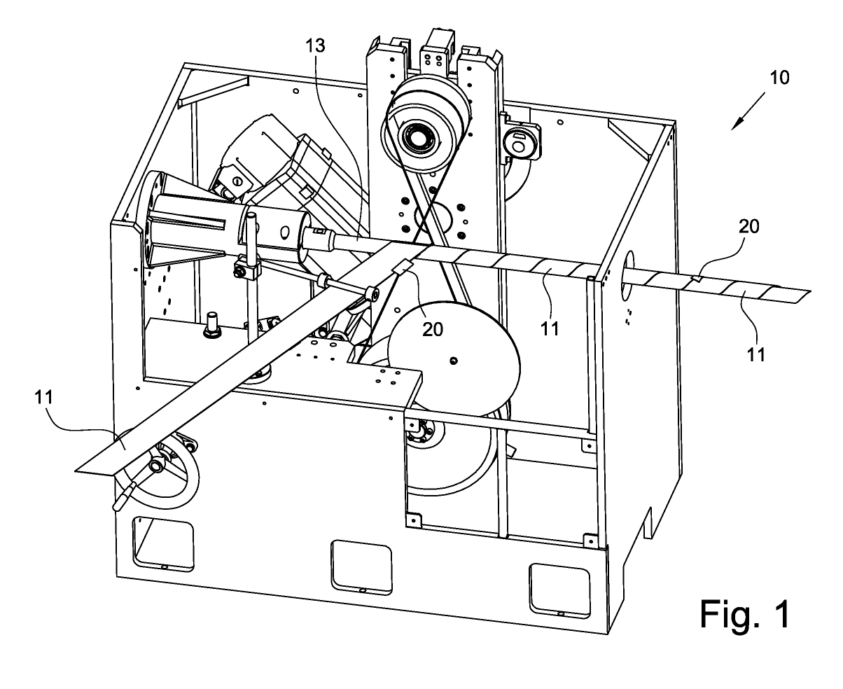

FIG. 1 is a schematic perspective view of an example embodiment of a tube machine according to the present invention;

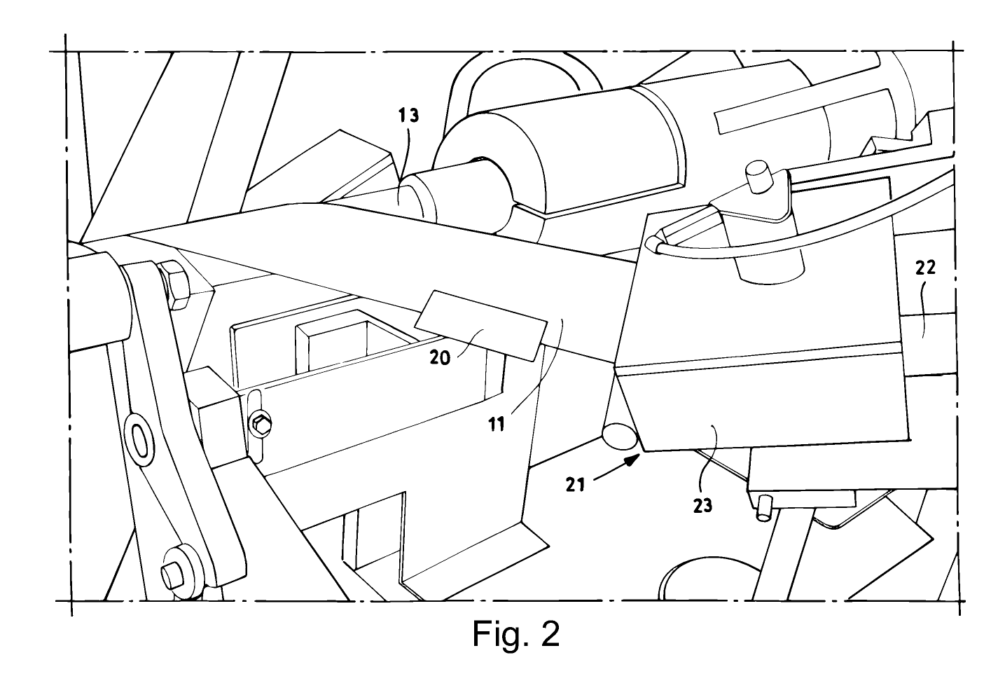

FIG. 2 shows an enlarged view of the means for arranging labels on the strip being fed to the winding pin;

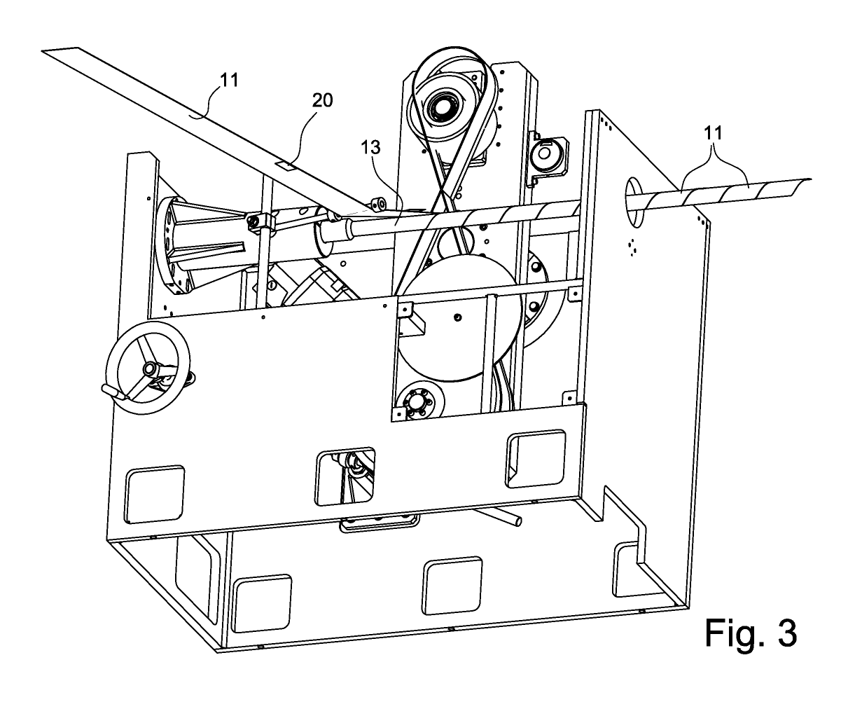

FIG. 3 is a schematic perspective view of a second example embodiment of a tube machine according to the present invention;

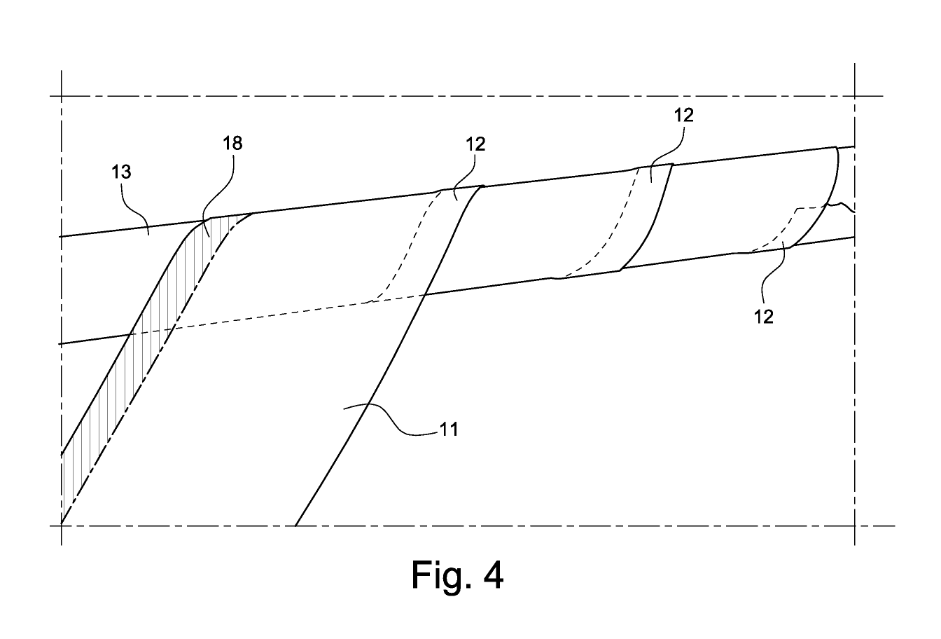

FIG. 4 shows the strip being wound on the pin; and

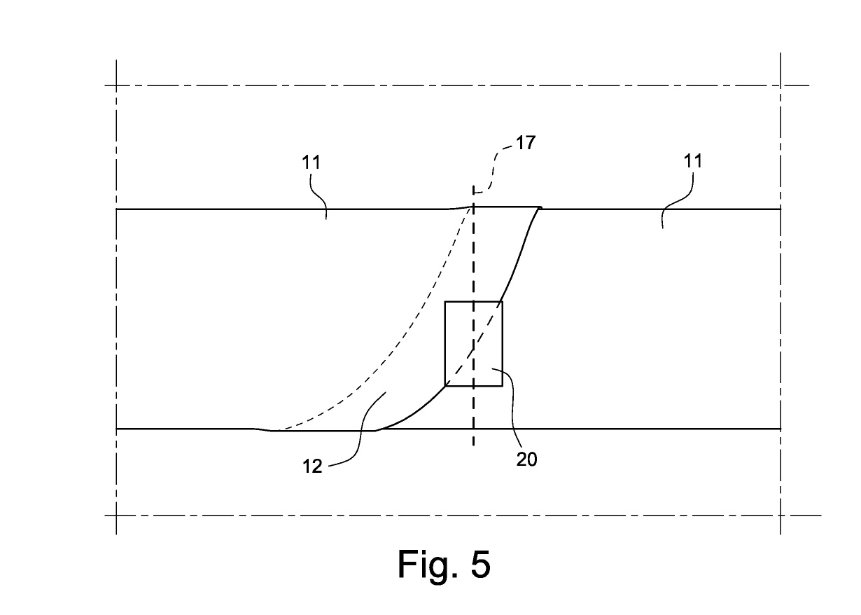

FIG. 5 shows an enlarged detail of a portion of tube ready to be cut highlighting the overlapping area with cold glue and the label arranged astride of the coils along the cutting line.

With reference to the figures, examples of machines for producing cardboard tubes according to the present invention comprising a winding pin 13 of a cardboard strip 11 are shown with 10.

As can be seen in FIG. 4 the cardboard strip 11 is wound in a coil pattern on the pin 13 partially overlapping so as to form an overlapping area 12 between subsequent turns of the coil.

Glue 18, preferably cold liquid glue, is deposited in such an overlapping area 12, in a continuous or discontinuous way.

According to the invention, the machine comprises means 21, 22, 23 for cyclically arranging adhesive labels 20 astride the side edge of the strip 11 at the areas undergoing the subsequent cutting operation 17.

The term “astride” is meant to indicate that the labels are arranged in a position such as to come into contact in the cutting area with portions of two wound coils of the strip 11.

The label can also be a known label available on the market having one side provided with adhesive.

In the example shown in FIG. 2, the means for cyclically arranging adhesive labels 20 on the strip comprises an application head 21 equipped with means 22 for applying and cutting labels obtained from a strip 23.

Of course, the machine can then provide a feeder of these labels 20 possibly made by joining a double-sided strip, which makes the adhesive face of the label, and a strip of non-adhesive material.

A first embodiment of the invention provides that the means for cyclically arranging the adhesive labels 20 are arranged upstream of the winding pin 13 so as to arrange the adhesive labels 20 on the strip 11 advancing in a rectilinear manner.

According to such an embodiment, the labels can be applied on the back or on the bottom of the strip 11 according to requirements.

Alternatively, the means for cyclically arranging adhesive labels 20 can be arranged downstream of the first winding of the strip 11 on the winding pin 13 to arrange the adhesive labels 20 astride of the coils of the strip 11 already wound.

In FIG. 5, the label is shown orthogonal to the cut 17 but alternatively, and preferably, it can be parallel to the edge of the strip 11 and, therefore, inclined with respect to the cutting line 17.

Advantageously, with the same means provided by the present invention without any modification, it is possible to provide the possibility of arranging a label on the strip 11, advancing in a rectilinear manner or being wound, in an intermediate position between two cutting lines 17.

Such an intermediate label can be for commercial or advertising purposes, carrying messages intended for the end customer.

In the detail of the embodiment in which it is provided to arrange the label 20 on the bottom of the strip 11, the label is preferably of the double-sided type and arranged flush with the edge of the strip 11 in the area that will be cut. In this way the double-sided label performs the same tasks as the hot glue of the prior art but without the drawbacks related to the high temperature.

A similar embodiment could provide to arrange a label of “noble material” on the bottom of the strip 11, always flushing with the edge in the area that will be cut.

Such a label of “noble material” is in particular applied in the overlapping area before dispensing the cold liquid glue 18, wherein “noble material” is meant to indicate a material different from that of the strip 11 and capable of interacting better with the cold liquid glue 18.

Such an embodiment would make up for the “slow” reaction of the strip 11 with the cold liquid glue 18 ensuring better adhesion of the edges in the cutting area.

The method for producing cardboard tubes through the machine 10 according to the invention provides, in short, the steps of:

supplying in a rectilinear manner the strip 11 having glue to a winding pin 13;

winding the strip 11 in a coil pattern on the winding pin 13 so as to form an overlapping area 12 between subsequent turns of the coil; and

cutting to size the coil of the cardboard strip 11 wound on the pin 13.

According to the invention the method also comprises the step of cyclically arranging adhesive labels 20 astride the edge of the strip 11 at the areas undergoing the subsequent cutting operation 17.

The tube machine thus conceived can undergo numerous modifications and variants, all of which are covered by the invention; moreover, all of the details can be replaced by technically equivalent elements. In practice, the materials used, as well as the sizes, can be whatever according to the technical requirements.

1. Machine for producing a tubular element by winding a cardboard strip (11) in a coil pattern and subsequently cutting it (17) to size; said machine being of the type comprising a winding pin (13) on which said cardboard strip (11) is wound in a coil pattern partially overlapping so as to form an overlapping area (12) between subsequent turns of the coil and a glue dispenser (18) configured to apply said glue (18) on said strip (11) within said overlapping area (12); characterised in that it comprises means (21, 22, 23) for cyclically arranging adhesive labels (20) astride the edge of said strip (11) at the areas undergoing the subsequent cutting operation (17).

2. Machine (10) according to claim 1 characterised in that said means for cyclically applying adhesive labels (20) are arranged upstream of said winding pin (13) for arranging said adhesive labels (20) on said strip (11) advancing in a rectilinear manner.

3. Machine (10) according to claim 2 characterised in that said means for cyclically arranging said adhesive labels (20) are configured to arrange said labels on the back of said strip (11) advancing in a rectilinear manner.

4. Machine (10) according to claim 2 characterised in that said means for cyclically arranging adhesive labels (20) are configured to arrange said labels on the bottom of said strip (11) advancing in a rectilinear manner.

5. Machine (10) according to claim 1 characterised in that said means for cyclically arranging adhesive labels (20) are arranged downstream of the first winding of said strip (11) on said winding pin (13) for arranging said adhesive labels (20) on said strip (11) being wound.

6. Method for producing a tubular element from a cardboard strip (11) comprising the steps of:
supplying in a rectilinear manner said strip (11) having said glue to a winding pin (13);
winding said strip (11) on said winding pin (13) in a coil pattern so as to form an overlapping area (12) between subsequent turns of the coil; and
cutting to size said coil of said cardboard strip (11) wound on said pin (13);
characterised in that it also comprises the step of cyclically arranging the adhesive labels (20) astride of the edge of said strip (11) at the areas undergoing the subsequent cutting operation (17).

7. Method according to claim 6 characterised in that said step of cyclically arranging adhesive labels (20) is carried out during the step of supplying said strip (11) in a rectilinear manner to said winding pin (13).

8. Method according to claim 7 characterised in that said step of cyclically arranging adhesive labels (20) is carried out by applying said adhesive labels (20) to the back of said strip (11).

9. Method according to claim 7 characterised in that said step of cyclically arranging adhesive labels (20) is carried out by applying said adhesive labels (20) to the bottom of said strip (11).

10. Method according to claim 6 characterised in that said step of cyclically arranging adhesive labels (20) is carried out during the winding step of said strip (11) on said winding pin (13).
